(19) United States
(12) Patent Application Publication
(10) Pub. No.: US 2025/0170672 A1
(43) Pub. Date: May 29, 2025

(54) NUMERICAL APERTURE CHANGING APPARATUS, LASER APPARATUS, AND LASER BEAM MACHINE

(71) Applicant: Mitsubishi Electric Corporation, Tokyo (JP)

(72) Inventors: Tomohiro KYOTO, Tokyo (JP); Hiroshi KIKUCHI, Tokyo (JP); Kyohei ISHIKAWA, Tokyo (JP); Masato KAWASAKI, Tokyo (JP)

(73) Assignee: Mitsubishi Electric Corporation, Tokyo (JP)

(21) Appl. No.: 18/878,658

(22) PCT Filed: Aug. 2, 2022
(86) PCT No.: PCT/JP2022/029624

§ 371 Date: Dec. 24, 2024

(51) Int. Cl. B23K 26/064; G02B 6/42

(52) U.S. Cl. CPC B23K 26/064; G02B 6/4296

(57) ABSTRACT

A numerical aperture changing apparatus for rearranging spatial distributions or spatial positions of a plurality of laser beams incident from a laser oscillator, and condensing the plurality of rearranged laser beams for entry of the beams into a transmission fiber, the numerical aperture changing apparatus including: a light shielding member provided on an extension of an optical axis of the transmission fiber, the light shielding member blocking a reflected laser beam, the reflected laser beam being a laser beam traveling from the transmission fiber toward the laser oscillator.

### FIELD

The present disclosure relates to a numerical aperture changing apparatus, a laser apparatus, and a laser beam machine that change an input numerical aperture of a transmission fiber.

### BACKGROUND

A laser beam machine generally includes a laser oscillator, a condenser lens, a transmission fiber, and a machining head. The condenser lens condenses a laser beam emitted from the laser oscillator. The transmission fiber propagates the laser beam condensed by the condenser lens. The machining head applies the laser beam from the transmission fiber to a desired position on a workpiece. Among such laser beam machines is a known laser beam machine that has a plurality of laser beams enter a single transmission fiber for the purpose of achieving higher output.

Patent Literature 1 discloses a beam parameter adjustment system that changes the spatial distribution of a plurality of beams having a polarization state and a collective spatial distribution from a beam source, and converges the beams with the changed spatial distribution onto an end face of a transmission fiber. In the technique described in Patent Literature 1, respective polarization states of the plurality of beams are changed. As a result, the spatial distribution of the beams that enter the transmission fiber is changed to adjust the parameter product of an output beam from the transmission fiber.

### CITATION LIST

### Patent Literature

Patent Literature 1: Japanese Translation of PCT International Application Laid-open No. 2017-506769

### SUMMARY OF INVENTION

### Problem to be Solved by the Invention

In a case where the technique described in Patent Literature 1 is applied to a laser beam machine including a transmission fiber having the same incident axis as an axis of an incident laser beam on a beam emitting source side, a laser beam reflected from a workpiece unfortunately returns to a laser oscillator serving as the beam emitting source as the reflected laser beam is in distribution centered on the incident axis of the transmission fiber. This presents a problem of the reflected laser beam damaging the laser oscillator.

The present disclosure has been made in view of the above, and an object of the present disclosure is to obtain a numerical aperture changing apparatus capable of preventing a laser oscillator from being damaged by a reflected laser beam returning in distribution centered on an incident axis of a transmission fiber.

### Means to Solve the Problem

To solve the problem and achieve the object, the present disclosure provides a numerical aperture changing apparatus for rearranging spatial distributions or spatial positions of a plurality of laser beams incident from a laser oscillator, and condensing the plurality of rearranged laser beams for entry of the beams into a transmission fiber, the numerical aperture changing apparatus comprising: a light shielding member provided on an extension of an optical axis of the transmission fiber, the light shielding member blocking a reflected laser beam, the reflected laser beam being a laser beam traveling from the transmission fiber toward the laser oscillator.

### Effects of the Invention

The numerical aperture changing apparatus according to the present disclosure has the effect of preventing a laser oscillator from being damaged by the reflected laser beam returning in distribution centered on the incident axis of the transmission fiber.

### BRIEF DESCRIPTION OF DRAWINGS

FIG. 1 is a diagram schematically illustrating an exemplary configuration of a laser beam machine according to a first embodiment.

FIG. 2 is a diagram schematically illustrating an exemplary configuration of a numerical aperture changing apparatus according to the first embodiment.

FIG. 3 is a side view of a beam spacing changer, which schematically illustrates an exemplary configuration of the beam spacing changer in the numerical aperture changing apparatus according to the first embodiment.

FIG. 4 is a diagram schematically illustrating an exemplary method for changing a numerical aperture in the numerical aperture changing apparatus according to the first embodiment.

FIG. 5 is a diagram showing an example of changes in the state of arrangement of laser beams in an XY-plane of FIG. 4.

FIG. 6 is a diagram illustrating an exemplary hardware configuration of a control device of the laser beam machine according to the first embodiment.

### DESCRIPTION OF EMBODIMENTS

A numerical aperture changing apparatus, a laser apparatus, and a laser beam machine according to an embodiment of the present disclosure will be hereinbelow described in detail with reference to the drawings.

### First Embodiment

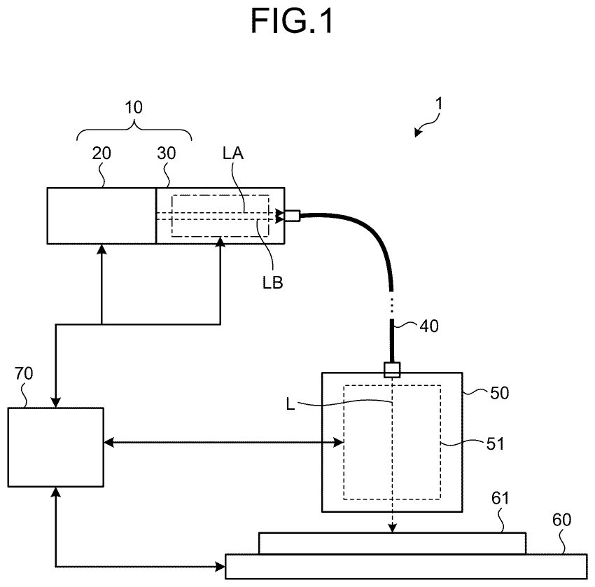

FIG. 1 is a diagram schematically illustrating an exemplary configuration of a laser beam machine according to a first embodiment. A laser beam machine 1 is a machine tool that machines a machining target, or a workpiece 61 by irradiating the workpiece 61 with a laser beam L that is a laser beam.

The laser beam machine 1 includes a laser apparatus 10, a transmission fiber 40, a machining head 50, a machining table 60, and a control device 70. The laser apparatus 10 outputs a laser beam L. The transmission fiber 40 propagates the laser beam L. The machining head 50 irradiates the workpiece 61 with the laser beam L from the transmission fiber 40. The machining table 60 supports the workpiece 61. The control device 70 controls the entire laser beam machine 1.

The laser apparatus 10 includes a laser oscillator 20 and a numerical aperture (NA) changing apparatus 30. The laser oscillator 20 is a light source. The numerical aperture changing apparatus 30 changes the input numerical aperture of the transmission fiber 40.

The laser oscillator 20 is a light source that emits laser beams LA and LB, such as a solid-state laser, a gas laser, or a semiconductor laser. The laser oscillator 20 emits the plurality of laser beams LA and LB. A single laser oscillator 20 may emit the plurality of laser beams LA and LB. Alternatively, a plurality of the laser oscillators 20 may each emit corresponding one of the laser beams LA and LB. The laser oscillator 20 is disposed such that positions of the plurality of laser beams LA and LB are symmetrical with respect to an extension of an optical axis of the transmission fiber 40. The laser oscillator 20 causes the plurality of laser beams LA and LB to enter the 10 numerical aperture changing apparatus 30.

The numerical aperture changing apparatus 30 interconnects the laser oscillator 20 and the transmission fiber 40. The numerical aperture changing apparatus 30 rearranges or redetermines spatial distributions or spatial 15 positions of the plurality of laser beams LA and LB incident from the laser oscillator 20, and condenses the plurality of thus rearranged laser beams LA and LB for entry of the beams into an input end of the transmission fiber 40. A laser beam obtained by condensation of the 20 laser beams LA and LB propagated through the transmission fiber 40 is referred to as the laser beam L. Numerical apertures represent the measures of an acceptance angle and an exit angle for the transmission fiber 40. The numerical aperture changing apparatus 30 can also be referred to as 25 an apparatus that changes the input numerical aperture and output numerical aperture of the transmission fiber 40.

The acceptance angle of the transmission fiber 40 has a maximum value. The maximum value refers to a maximum acceptance angle at which the laser beam L can travel in 30 total reflection through the transmission fiber 40. Meanwhile, the input numerical aperture has a minimum value in addition to a value corresponding to the maximum value of the acceptance angle described above. The minimum value is determined by the quality of a laser beam output from the laser oscillator 20 and the structure of the numerical aperture changing apparatus 30, as will be described later. The numerical aperture changing apparatus 30 changes the input numerical aperture such that the input numerical aperture ranges between the minimum value and maximum value of the input numerical aperture. The input numerical aperture is performed by rearrangement, or redetermination of the spatial distributions or the spatial positions, of the plurality of laser beams LA and LB. An example of rearrangement of the plurality of laser beams LA and LB is change of a beam spacing between the plurality of laser beams LA and LB. Note that FIG. 1 schematically illustrates the numerical aperture changing apparatus 30. In FIG. 1, broken line arrows shown between the laser oscillator 20 and the input end of the transmission fiber 40 indicate how the laser beams LA and LB pass through the numerical aperture changing apparatus 30.

The input end of the transmission fiber 40 is connected to the laser apparatus 10, specifically, the numerical aperture changing apparatus 30. An output end of the transmission fiber 40 is connected to the machining head 50. The laser beam L propagated through the transmission fiber 40 enters the machining head 50. The transmission fiber 40, which is an optical waveguide that propagates the laser beam L, includes a core and a cladding. The cladding covers the periphery of the core with a material having a refractive index lower than a refractive index of the core. Such a structure of the transmission fiber 40 allows the laser beam L to travel in total reflection with an input numerical aperture equal to or less than the maximum value of the input numerical aperture of the transmission fiber 40.

The machining head 50 is connected to the laser apparatus 10 via the transmission fiber 40, and irradiates the workpiece 61 with the laser beam L propagated through the transmission fiber 40. The machining head 50 includes a transmission optical system 51 that guides the laser beam L to an emission port of the machining head 50. Thus, the machining head 50 applies the laser beam L to a predetermined position on the workpiece 61. Although not illustrated, the transmission optical system 51 includes a condensing optical system that condenses the laser beam L from the transmission fiber 40. The laser beam L emitted from the machining head 50 is incident on the workpiece 61. In FIG. 1, a broken line arrow between the output end of the transmission fiber 40 and the workpiece 61 indicates how the laser beam L emitted from the output end of the transmission fiber 40 reaches the workpiece 61.

The machining table 60 is a table on which the workpiece 61 is placed. The machining table 60 preferably includes a fixation mechanism that fixes the workpiece 61 so that the workpiece 61 does not move during machining.

The laser beam machine 1 moves the laser beam L and the workpiece 61 relative to each other by moving the machining table 60 with respect to the machining head 50. Note that the laser beam machine 1 may move the laser beam L and the workpiece 61 relative to each other without moving the machining table 60. The laser beam machine 1 may fix the position of the machining table 60 and control the incident position of the laser beam L on the workpiece 61.

The control device 70 transmits a control signal to each of the laser oscillator 20, the numerical aperture changing apparatus 30, the machining head 50, and the machining table 60, and controls operation thereof. The laser oscillator 20 outputs the laser beams LA and LB according to the control signal. The numerical aperture changing apparatus 30 operates in accordance with the control signal to change the input numerical aperture of the transmission fiber 40 for the laser beam L. The machining head 50 operates according to the control signal. The machining table 60 operates according to the control signal. In this manner, the control device 70 controls each of the laser oscillator 20, the numerical aperture changing apparatus 30, the machining head 50, and the machining table 60. Note that a processing unit of the control device 70, which controls operation of the numerical aperture changing apparatus 30, is a control device that causes the numerical aperture changing apparatus 30 to operate. Thus, the processing unit can be considered a part of the numerical aperture changing apparatus 30.

The control device 70, which controls the numerical aperture changing apparatus 30 for changing the input numerical aperture of the transmission fiber 40, adjusts the output numerical aperture at the output end of the transmission fiber 40. That is, the numerical aperture changing apparatus 30 and the control device 70 control the input numerical aperture of the transmission fiber 40 to thereby control the output numerical aperture of the transmission fiber 40.

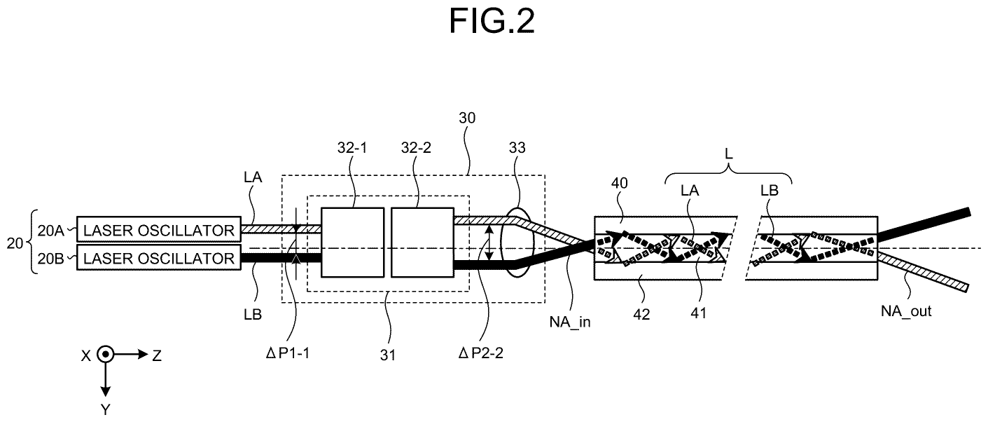

Next, the numerical aperture changing apparatus 30 will be described in detail. FIG. 2 is a diagram schematically illustrating an exemplary configuration of the numerical aperture changing apparatus according to the first embodiment. FIG. 2 illustrates not only the numerical aperture changing apparatus 30 but also the laser oscillator 20 and the transmission fiber 40. Furthermore, FIG. 2 illustrates a case where the numerical aperture changing apparatus 30 changes the input numerical aperture of the transmission fiber 40 by changing a spacing between the two laser beams LA and LB, that is, the laser beam LA from a laser oscillator 20A and the laser beam LB from a laser oscillator 20B. Assume that a Z-axis direction is defined as a direction in which the laser beams LA and LB travel in the laser oscillators 20A and 20B, and two axes perpendicular to a Z-axis are defined as an X-axis and a Y-axis. In this case, the laser oscillators 20A and 20B are disposed side by side along a Y-axis direction. In addition, the laser oscillators 20A and 20B are disposed such that the laser oscillators 20A and 20B are symmetric with respect to an extension that is an extended optical axis of the transmission fiber 40.

The numerical aperture changing apparatus 30 includes a beam spacing changer 31 and a condensing optical system 33. The beam spacing changer 31 changes a beam spacing that is a spacing between the plurality of laser beams LA and LB. The condensing optical system 33 concentrates the laser beams LA and LB with the beam spacing changed, into the input end of the transmission fiber 40.

In a case where beam characteristics of the plurality of laser beams LA and LB are directional in an XY-plane, the beam spacing changer 31 includes two or more beam spacing changing units 32-1 and 32-2. In the example of FIG. 2, the beam spacing changer 31 includes two beam spacing changing units 32-1 and 32-2. The beam spacing changing unit 32-1 changes a beam spacing in a first direction perpendicular to the Z-axis. The beam spacing changing unit 32-2 changes a beam spacing in a second direction different from the first direction. The beam spacing changer 31 changes a beam spacing ΔP1-1 between the laser beams LA and LB emitted from the laser oscillators 20A and 20B, respectively, to a beam spacing ΔP2-2. In this case, the first direction corresponds to an X-axis direction, and the second direction corresponds to the Y-axis direction. In addition, changing the spacing between the laser beams LA and LB corresponds to changing the positions of the laser beams LA and LB in the XY-plane. In other words, the beam spacing changer 31 is a device that changes arrangement of the plurality of laser beams LA and LB in the XY-plane.

The condensing optical system 33 condenses the laser beams LA and LB with the beam spacing changed by the beam spacing changer 31, and causes the laser beams LA and LB to enter the transmission fiber 40. The condensing optical system 33 includes one or more lenses. The condensing optical system 33 includes a single lens in the example of FIG. 2, but may include two or more lenses. Note that in the case of the condensing optical system 33 including two or more lenses, the input numerical aperture NA_in of the transmission fiber 40 can also be changed by the condensing optical system 33.

As illustrated in FIG. 2, the transmission fiber 40 includes a core 41 and a cladding 42. The cladding 42 covers the periphery of the core 41, and is made of a material having a refractive index lower than a refractive index of the core 41. The laser beam L concentrated into the input end of the transmission fiber 40 follows paths indicated by dotted lines by total reflection, and is emitted from the output end at an output numerical aperture NA_out determined in association with the input numerical aperture NA_in.

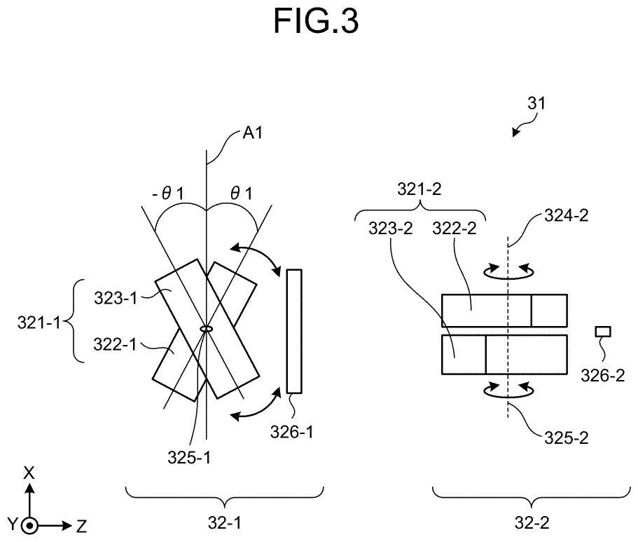

FIG. 3 is a side view of the beam spacing changer, which schematically illustrates an exemplary configuration of the beam spacing changer in the numerical aperture changing apparatus according to the first embodiment. As described above, the beam spacing changer 31 includes the beam spacing changing unit 32-1 and the beam spacing changing unit 32-2.

The beam spacing changing unit 32-1 includes a beam rearrangement unit 321-1 and a light shielding member 326-1. The beam rearrangement unit 321-1 includes a combination of two planar transmission plates 322-1 and 323-1 that transmit the laser beams LA and LB, respectively. The two transmission plates 322-1 and 323-1 of the beam rearrangement unit 321-1 are rectangular plate-like planar substrates equal in size. The two transmission plates 322-1 and 323-1 are disposed at a predetermined interval in the Y-axis direction. A rotation shaft (not illustrated) is provided at the center of the transmission plate 322-1 in a ZX-plane, and a rotation mechanism (not illustrated) is provided on the rotation shaft. As a result, the transmission plate 322-1 rotates about the rotation shaft (not illustrated). A rotation shaft 325-1 is provided at the center of the transmission plate 323-1 in the ZX-plane, and a rotation mechanism (not illustrated) is provided on the rotation shaft 325-1. As a result, the transmission plate 323-1 rotates about the rotation shaft 325-1. The two transmission plates 322-1 and 323-1 are disposed such that the transmission plates 322-1 and 323-1 are inclined at the same angle θ1 in opposite directions with respect to a straight line A1. The straight line A1 passes through the rotation shaft 325-1, and is parallel to the X-axis. Assuming that a clockwise rotational direction from the straight line A1 is defined as a positive direction and a counterclockwise rotational direction is defined as a negative direction, the transmission plates 322-1 and 323-1 are disposed in the example of FIG. 3 such that the transmission plate 322-1 is inclined at an angle of θ1, and the transmission plate 323-1 is inclined at an angle of −θ1. The two transmission plates 322-1 and 323-1 are arranged symmetrically with respect to the optical axis of the transmission fiber 40. The rotation mechanisms each rotate the corresponding one of the two transmission plates 322-1 and 323-1 in accordance with an instruction from the control device 70.

The light shielding member 326-1 is a member that is disposed on the extension of the optical axis of the transmission fiber 40, and blocks a reflected laser beam that is a laser beam traveling from the transmission fiber 40 toward the laser oscillators 20A and 20B. That is, the light shielding member 326-1 is disposed so as to prevent a laser beam reflected by the workpiece 61 from returning to the laser oscillator 20. In the example of FIG. 3, the light shielding member 326-1 is disposed between the two transmission plates 322-1 and 323-1, and has a shape extending in the X-axis direction.

The beam spacing changing unit 32-2 includes a beam rearrangement unit 321-2 and a light shielding member 326-2. The beam rearrangement unit 321-2 includes a combination of two planar transmission plates 322-2 and 323-2 that transmit the laser beams LA and LB, respectively. The two transmission plates 322-2 and 323-2 of the beam rearrangement unit 321-2 are rectangular plate-like planar substrates equal in size. The two transmission plates 322-2 and 323-2 are disposed at a predetermined interval in the X-axis direction. A rotation shaft 324-2 is provided at the center of the transmission plate 322-2 in a YZ-plane, and a rotation mechanism (not illustrated) is provided on the rotation shaft 324-2. As a result, the transmission plate 322-2 rotates about the rotation shaft 324-2. A rotation shaft 325-2 is provided at the center of the transmission plate 323-2 in the YZ-plane, and a rotation mechanism (not illustrated) is provided on the rotation shaft 325-2. As a result, the transmission plate 323-2 rotates about the rotation shaft 325-2. The two transmission plates 322-2 and 323-2 are disposed such that the transmission plates 322-2 and 323-2 are inclined at the same angle in opposite directions with respect to a straight line that passes through the rotation shafts 324-2 and 325-2 in parallel to the Y-axis. The two transmission plates 322-2 and 323-2 are arranged symmetrically with respect to the optical axis of the transmission fiber 40. The rotation mechanisms each rotate the corresponding one of the two transmission plates 322-2 and 323-2 in accordance with an instruction from the control device 70.

The light shielding member 326-2 is a member that is disposed on the extension of the optical axis of the transmission fiber 40, and blocks a reflected laser beam traveling from the transmission fiber 40 toward the laser oscillators 20A and 20B. That is, the light shielding member 326-2 is disposed so as to prevent a laser beam reflected by the workpiece 61 from returning to the laser oscillator 20. In one example, the light shielding member 326-2 may be disposed between the two transmission plates 322-2 and 323-2, and may have a shape extending in the Y-axis direction.

The transmission plates 322-1, 322-2, 323-1, and 323-2 are preferably made of an optically isotropic material transparent to wavelengths of the laser beams LA and LB oscillated by the laser oscillator 20. In a case where the laser oscillators 20A and 20B are fiber lasers that oscillate the laser beams LA and LB with wavelengths of around 1070 nm, an example of the transmission plates 322-1, 322-2, 323-1, and 323-2 is a glass substrate such as synthetic quartz.

The light shielding members 326-1 and 326-2 are provided for the plurality of beam spacing changing units 32-1 and 32-2, respectively, and are located on sides closer to the transmission fiber 40 with respect to the beam spacing changing units 32-1 and 32-2, respectively. The light shielding members 326-1 and 326-2 have only to perform any light shielding for reflection or absorption of the laser beam. A material to be used as the light shielding members 326-1 and 326-2 depends on the wavelength of the laser beam L to be emitted by the laser oscillator 20. An example of the light shielding members 326-1 and 326-2 in the case of performing light shielding by reflection is surface-treated copper. An example of the light shielding members 326-1 and 326-2 in the case of performing light shielding by absorption is aluminum subjected to alumite treatment. Furthermore, the light shielding members 326-1 and 326-2 may each have a cooling mechanism. The cooling mechanisms include pipes and refrigerant supply units. The pipes are provided in the light shielding members 326-1 and 326-2 or in contact with the light shielding members 326-1 and 326-2. Each refrigerant supply unit carries a refrigerant through the pipe. An example of the refrigerant is water. The flow of water from the refrigerant supply units to the pipes will prevent an increase in the temperature of the light shielding members 326-1 and 326-2.

The light shielding member 326-1 is disposed between the two transmission plates 322-1 and 323-1, and the light shielding member 326-2 is disposed between the two transmission plates 322-2 and 323-2. For this reason, at least one of the size and arrangement of the light shielding members 326-1 and 326-2 is determined such that output loss due to the blocking of the plurality of laser beams LA and LB at the light shielding members 326-1 and 326-2 becomes 10% or less when the spatial distributions or the spatial positions, of the plurality of incident laser beams LA and LB are brought closest to each other in the numerical aperture changing apparatus 30,. Thus, the shape of the light shielding members 326-1 and 326-2 illustrated in FIG. 3 is an example, and the light shielding members 326-1 and 326-2 may have other shapes.

The laser beams LA and LB each have an arching beam intensity. That is, the laser beams LA and LB provide a Gaussian distribution where beam intensity is high at the center and decreases toward outer edges. In this case, the Gaussian beam diameter is defined as a beam width of a beam with a beam intensity reduced by 1/e² from a peak intensity. When this Gaussian beam diameter is used, the laser beams LA and LB have portions of about 10% of their beam diameters, the portions being off the Gaussian beam diameter. Considering that the Gaussian beam diameter portions of the laser beams LA and LB pass through the transmission plates, it is desirable that the output loss caused by the blocking at the light shielding members 326-1 and 326-2 be kept at 10% or less as described above. In addition, optical components of the laser beam machine 1 are generally designed optically with a Gaussian beam diameter in many cases. In view of this, it is desirable to design the optical components such that the output loss of the laser beams LA and LB due to the blocking at the light shielding members 326-1 and 326-2 is 10% or less.

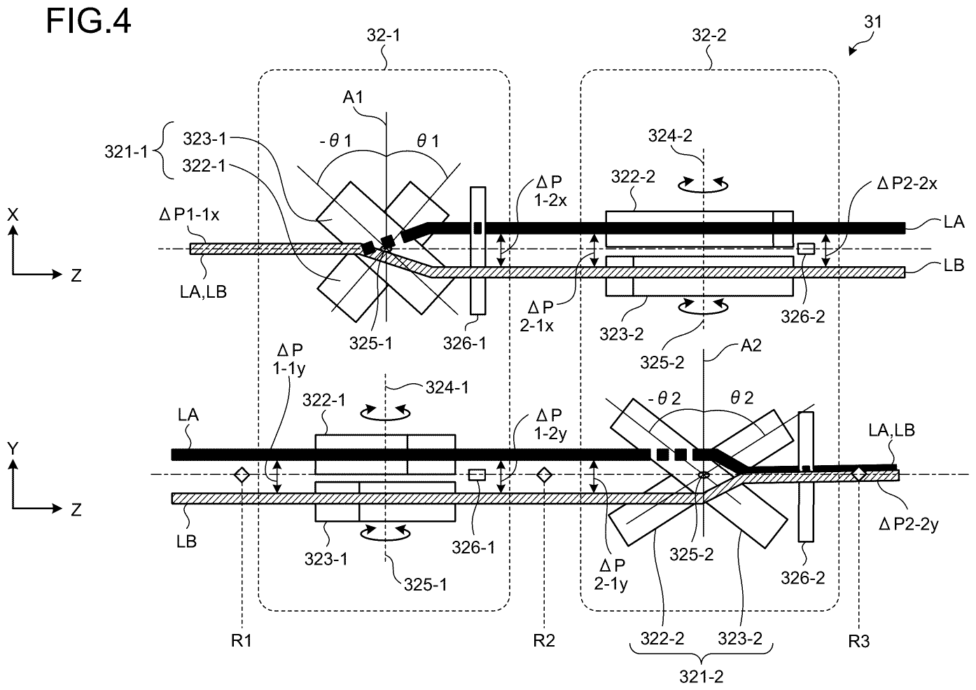

A method for adjusting the beam spacing in the numerical aperture changing apparatus 30 will be hereinbelow described. FIG. 4 is a diagram schematically illustrating an exemplary method for changing a numerical aperture in the numerical aperture changing apparatus according to the first embodiment. FIG. 4 illustrates only the beam spacing changing units 32-1 and 32-2 of the numerical aperture changing apparatus 30 of FIG. 2. In addition, for convenience, FIG. 4 simultaneously illustrates side views of the beam spacing changing units 32-1 and 32-2 viewed from the Y-axis direction and side views of the beam spacing changing units 32-1 and 32-2 viewed from the X-axis direction. That is, FIG. 4 simultaneously illustrates views of the beam spacing changing units 32-1 and 32-2 on the ZX-plane and views of the beam spacing changing units 32-1 and 32-2 on the YZ-plane.

In the beam spacing changer 31 of the numerical aperture changing apparatus 30 of FIG. 4, the beam spacing changing unit 32-1 is disposed on a side closer to the laser oscillator 20, and the beam spacing changing unit 32-2 is disposed on a side closer to the transmission fiber 40. The beam spacing changing unit 32-1 changes a beam spacing in the X-axis direction without changing a beam spacing in the Y-axis direction. The beam spacing changing unit 32-2 changes a beam spacing in the Y-axis direction without changing a beam spacing in the X-axis direction. Note that the method is illustrated by way of example in FIG. 4, and the beam spacing changing unit 32-1 and the beam spacing changing unit 32-2 may change beam spacings in any directions different from each other.

In the example of FIG. 4, the transmission plates 322-1 and 323-1 of the beam spacing changing unit 32-1 are rotated by angles of θ1 and −θ1, respectively, with respect to the straight line A1. Furthermore, the transmission plates 322-2 and 323-2 of the beam spacing changing unit 32-2 are rotated by angles of θ2 and −θ2, respectively, with respect to a straight line A2. The straight line A2 is a straight line that passes through the rotation shafts 324-2 and 325-2 in parallel to the X-axis. The angles θ1 and θ2 are set to any desired angles such that the input numerical aperture NA_in of the transmission fiber 40 has a predetermined value.

Assume that the laser oscillators 20A and 20B are arranged symmetrically with respect to the optical axis of the transmission fiber 40 at an interval in the Y-axis direction. The laser oscillators 20A and 20B output the laser beams LA and LB, respectively. A beam spacing between the laser beams LA and LB in the X-axis direction is denoted by ΔP1-1x, and a beam spacing therebetween in the Y-axis direction is denoted by ΔP1-1y.

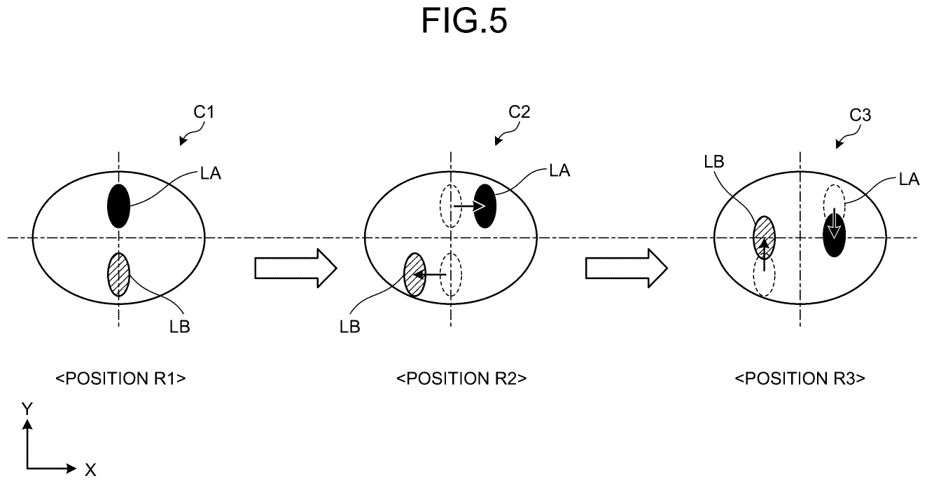

FIG. 5 is a diagram showing an example of changes in the state of arrangement of laser beams in an XY-plane of FIG. 4. FIG. 5 illustrates arrangement states in a plane perpendicular to the direction in which the laser beams LA and LB travel at positions R1, R2, and R3 in optical paths of the laser beams LA and LB in FIG. 4. Before entering the beam spacing changing unit 32-1, the laser beams LA and LB are arranged at an interval in the Y-axis direction as illustrated in an arrangement state C1 at the position R1. In addition, the laser beams LA and LB have a beam shape narrower in the X-axis direction than in the Y-axis direction, that is, an elliptical beam shape having a longer diameter in the Y-axis direction than in the X-axis direction. Then, the laser beams LA and LB enter the beam spacing changing unit 32-1 in the arrangement state C1.

Returning to FIG. 4, the two transmission plates 322-1 and 323-1 in the beam spacing changing unit 32-1 are disposed at an interval in the Y-axis direction, and a rotation shaft 324-1 and the rotation shaft 325-1 are parallel to the Y-axis. The transmission plate 322-1 is disposed in such a way as to transmit the laser beam LA from the laser oscillator 20A, and the transmission plate 323-1 is disposed in such a way as to transmit the laser beam LB from the laser oscillator 20B. Furthermore, the two transmission plates 322-1 and 323-1 in the beam spacing changing unit 32-1 are rotatable about the Y-axis. As described above, the transmission plate 322-1 and the transmission plate 323-1 are disposed such that the transmission plate 322-1 is inclined at the angle θ1 with respect to the straight line A1, and the transmission plate 323-1 is inclined at the angle −θ1 with respect to the straight line A1. It is possible to change a beam spacing in the X-axis direction by disposing the beam rearrangement unit 321-1 in that manner.

The laser beams LA and LB enter the beam spacing changing unit 32-1. The laser beam LA enters the transmission plate 322-1, and the laser beam LB enters the transmission plate 323-1. The laser beams LA and LB are refracted when entering the transmission plates 322-1 and 323-1, respectively. The laser beams LA and LB appear to be refracted when viewed in a direction in which the angles of incidence are provided, that is, when viewed in the ZX-plane. The laser beams LA and LB appear to travel in straight lines when viewed in a direction in which no angle of incidence is provided, that is, when viewed in the YZ-plane. Furthermore, the two transmission plates 322-1 and 323-1 are inclined in opposite directions at the same angle θ1 with respect to the straight line A1. As a result, the two laser beams LA and LB are refracted in directions away from each other in the ZX-plane. Meanwhile, the laser beams LA and LB are not refracted in the YZ-plane. Although the laser beams LA and LB partially strike the light shielding member 326-1, the laser beam LA passes on a back side away from the light shielding member 326-1 in the Y-axis direction in the ZX-plane, and the laser beam LB passes on a front side away from the light shielding member 326-1 in a direction opposite to the Y-axis direction in the ZX-plane.

The laser beams LA and LB output from the beam spacing changing unit 32-1 are arranged in a state indicated as an arrangement state C2 at the position R2 in FIG. 5. Dotted ellipses in the arrangement state C2 indicate the positions of the laser beams LA and LB in the arrangement state C1. As illustrated in FIG. 5, the laser beam LA and laser beam LB travel the same distance in opposite directions in the X-axis direction.

Returning to FIG. 4, a beam spacing between the laser beams LA and LB in the X-axis direction output from the beam spacing changing unit 32-1 is denoted by ΔP1-2x, and a beam spacing therebetween in the Y-axis direction is denoted by ΔP1-2y. In the example of FIG. 4, the beam spacing ΔP1-2x between the laser beams LA and LB in the X-axis direction output from the beam spacing changing unit 32-1 is larger than the beam spacing ΔP1-1x between the laser beams LA and LB that have not yet entered the beam spacing changing unit 32-1. Meanwhile, the beam spacing ΔP1-2y between the laser beams LA and LB in the Y-axis direction output from the beam rearrangement unit 321-1 is equal to the beam spacing ΔP1-1y between the laser beams LA and LB that have not yet entered the beam rearrangement unit 321-1.

A beam spacing in the X-axis direction between the two laser beams LA and LB input to the beam spacing changing unit 32-2 is denoted by ΔP2-1x, and a beam spacing therebetween in the Y-axis direction is denoted by ΔP2-1y. Note that the beam spacing ΔP2-1x in the X-axis direction is equal to ΔP1-2x, and the beam spacing ΔP2-1y in the Y-axis direction is equal to ΔP1-2y.

Such two laser beams LA and LB enter the beam spacing changing unit 32-2. The laser beam LA enters the transmission plate 322-2, and the laser beam LB enters the transmission plate 323-2. The laser beams LA and LB are refracted when entering the transmission plates 322-2 and 323-2, respectively. As in the beam spacing changing unit 32-1, the laser beams LA and LB appear to be refracted in the YZ-plane, which is a direction in which the angles of incidence are provided. In addition, the laser beams LA and LB appear to travel in straight lines in the ZX-plane, which is a direction in which no angle of incidence is provided. Furthermore, the two transmission plates 322-2 and 323-2 are inclined in opposite directions at the same angle θ2 with respect to the straight line A2. As a result, the laser beams LA and LB are not refracted in the ZX-plane. Meanwhile, in the YZ-plane, the two laser beams LA and LB are refracted in a direction in which the two laser beams LA and LB approach each other. Although the laser beams LA and LB partially strike the light shielding member 326-2, the laser beam LA passes on a back side away from the light shielding member 326-2 in the X-axis direction in the YZ-plane, and the laser beam LB passes on a front side away from the light shielding member 326-2 in a direction opposite to the X-axis direction in the YZ-plane. As a result, the two laser beams LA and LB are output from the beam spacing changing unit 32-2 such that a beam spacing in the X-axis direction between the two laser beams LA and LB is ΔP2-2x, and a beam spacing therebetween in the Y-axis direction is ΔP2-2y. In the example of FIG. 4, the beam spacing ΔP2-2x is equal to the beam spacing ΔP2-1x in the X-axis direction between the two laser beams LA and LB that have not yet entered the beam spacing changing unit 32-2. Meanwhile, the beam spacing ΔP2-2y is smaller than the beam spacing ΔP2-1y in the Y-axis direction between the two laser beams LA and LB that have not yet entered the beam spacing changing unit 32-2.

The laser beams LA and LB output from the beam spacing changing unit 32-2 are arranged in a state indicated as an arrangement state C3 at the position R3 in FIG. 5. Dotted ellipses in the arrangement state C3 indicate the positions of the laser beams LA and LB in the arrangement state C2. As illustrated in FIG. 5, the laser beam LA and laser beam LB travel the same distance in opposite directions in the Y-axis direction, and are located on the X-axis.

As described above, the two elliptical laser beams LA and LB extending in the Y-axis direction and arranged at an interval in the Y-axis direction as illustrated in the arrangement state C1 pass through the two beam spacing changing units 32-1 and 32-2, such that the laser beams LA and LB are arranged at an interval in the X-axis direction, as indicated in the arrangement state C3. That is, the laser beams LA and LB can be rearranged by the two beam spacing changing units 32-1 and 32-2.

When the beam qualities of the laser beams LA and LB differ between the X-axis direction and the Y-axis direction, it is possible to rearrange the laser beams LA and LB as described above, thereby changing the beam diameter and divergence angle of the laser beam L into which the laser beams LA and LB have been combined.

It is known that beam quality is represented by a product of a beam diameter and a divergence angle. The beam quality indicates that the quality of the laser beams LA and LB is better as a value obtained above is smaller.

The beam diameter of a single laser beam can be obtained by the Gaussian beam diameter as described above. Meanwhile, a beam diameter determined from energy distribution formed by the plurality of laser beams LA and LB can be used as the beam diameter of the laser beam into which the plurality of laser beams LA and LB has been combined. There are various definitions of the beam diameter. A beam diameter is herein considered a diameter that provides a predetermined percentage of energy of the laser beam. When a beam diameter is defined in this manner, the beam diameter of the laser beam into which the plurality of laser beams LA and LB has been combined varies depending on the arrangement of the plurality of laser beams LA and LB. As a result, beam quality changes.

A case where the plurality of laser beams LA and LB is combined in the arrangement state C1 of FIG. 5, that is, a case where the two laser beams LA and LB arranged in the Y-axis direction are combined is compared with a case where the plurality of laser beams LA and LB is combined in the arrangement state C3, that is, a case where the two laser beams LA and LB arranged in the X-axis direction are combined. The two laser beams LA and LB in an elliptical shape narrower in the X-axis direction than in the Y-axis direction are arranged at an interval in the Y-axis direction in the arrangement state C1, and are arranged at an interval in the X-axis direction in the arrangement state C3. The beam diameters of the laser beams LA and LB in the Y-axis direction are larger than the beam diameter thereof in the X-axis direction. It is therefore thought that the beam quality thereof in the Y-axis direction is worse than the beam quality thereof in the X-axis direction. In addition, in a case where a portion of the beam that includes a predetermined percentage of the entire energy is considered as providing a beam diameter, in which case the narrower the spacing between the two laser beams LA and LB, the smaller the beam diameter. In view of those findings, beam quality is considered better in the arrangement state C3 in which the laser beams LA and LB are arranged in the X-axis direction than in the arrangement state C1 in which the laser beams LA and LB are arranged at an interval in the Y-axis direction. For this reason, in FIG. 4, the two laser beams LA and LB are rearranged by use of the two beam spacing changing units 32-1 and 32-2 such that the arrangement state is changed from the arrangement state C1 to the arrangement state C3.

Note that the beam spacing changing unit 32-1 and the beam spacing changing unit 32-2 can change the beam spacings in different directions, and the angles of inclination of the beam spacing changing unit 32-1 and the beam spacing changing unit 32-2 can also be set to any desired angles. As described above, since the shapes of the laser beams LA and LB on the XY-plane are directional on the X-axis and the Y-axis, the amounts of displacement of beam positions in the X-axis direction and the Y-axis direction are set based on the shapes such that the numerical aperture of the laser beam L into which the plurality of laser beams LA and LB has been combined is substantially equal in the X-axis direction and the Y-axis direction. The reason why the numerical aperture of the laser beam L should be substantially equal in the X-axis direction and the Y-axis direction is that the output numerical aperture NA_out of the transmission fiber 40 depends on a larger input numerical aperture NA_in.

The relationship between the inclination angles of the transmission plates 322-1, 322-2, 323-1, and 323-2 and the beam spacings is obtained in advance by an experiment. In this way, the inclination angles of the transmission plates 322-1, 322-2, 323-1, and 323-2 can be obtained such that a laser beam obtained when the two laser beams LA and LB output from the beam spacing changing unit 32-2 are combined will have desired beam quality.

Based on the above findings about the beam quality, it is possible to obtain the best beam quality by overlapping the plurality of laser beams LA and LB such that the laser beams LA and LB match each other. However, there is a case where a reflected laser beam, which is the laser beam L emitted from the machining head 50 and reflected by the workpiece 61, returns toward the laser oscillator 20 in distribution centered on the optical axis of the transmission fiber 40. In view of such a case, in the first embodiment, the light shielding members 326-1 and 326-2 are disposed at positions corresponding to the optical axis of the transmission fiber 40 on the output sides of the beam spacing changing units 32-1 and 32-2, respectively, from which output sides the laser beams LA and LB are output. Since the light shielding members 326-1 and 326-2 are thus disposed, the plurality of laser beams LA and LB cannot be overlapped in such a way as to match each other. That is, there is a limit to reducing the spacing between the two laser beams LA and LB. In the presence of the light shielding members 326-1 and 326-2, a beam spacing that minimizes the beam quality of the two laser beams LA and LB is obtained. When the two laser beams LA and LB having a beam spacing that minimizes beam quality enter the input end of the transmission fiber 40 via the condensing optical system 33, the acceptance angle of the transmission fiber 40 represent a minimum value. That is, the input numerical aperture NA_in of the transmission fiber 40 is minimized.

Note that in order to minimize the beam quality of the two laser beams LA and LB, the plurality of laser beams LA and LB needs to be arranged symmetrically with respect to the extension of the optical axis of the transmission fiber 40. This is because when the two laser beams LA and LB are not symmetrical with respect to the extension of the optical axis of the transmission fiber 40, one of the two laser beams LA and LB has an incident angle larger than that of the other laser beam. Since the output numerical aperture NA_out of the transmission fiber 40 depends on a larger input numerical aperture NA_in, it is necessary to reduce the input numerical aperture NA_in of the transmission fiber 40 so as to reduce the output numerical aperture NA_out of the transmission fiber 40. In order to reduce the input numerical aperture NA_in of the transmission fiber 40, it is necessary for the laser beam to enter the transmission fiber 40 from the extension of the optical axis of the transmission fiber 40 as much as possible. Then, the input numerical aperture NA_in of the transmission fiber 40 is minimized when the two laser beams LA and LB are arranged in such a manner that the output loss of the laser beams LA and LB caused by the blocking at the light shielding members 326-1 and 326-2 is 10% or less and the two laser beams LA and LB having the spatial distributions or the spatial positions brought closest to each other are symmetric with respect to the extension of the optical axis of the transmission fiber 40.

As described above, not all of the laser beam L having entered the transmission fiber 40 is propagated in total reflection. The laser beam L traveling in total reflection through the transmission fiber 40 is limited to the laser beam L having entered the transmission fiber 40 at an angle equal to or less than the maximum value of the acceptance angle of the transmission fiber 40. The laser beam L having entered at an angle larger than the maximum value of the acceptance angle of the transmission fiber 40 fails to travel through the transmission fiber 40, and becomes radiation light, leading to loss. At the maximum value of the acceptance angle of the transmission fiber 40, the input numerical aperture NA_in of the transmission fiber 40 is maximized.

As described above, the rotation angles of the transmission plates 322-1, 322-2, 323-1, 323-2 of the beam spacing changing units 32-1 and 32-2 of the numerical aperture changing apparatus 30 are adjusted to thereby make it possible to change the input numerical aperture NA_in of the transmission fiber 40 between the minimum value and the maximum value. That is, under the condition that the input numerical aperture should fall between the minimum value and the maximum value, the rotation angles of the transmission plates 322-1, 322-2, 323-1, and 323-2 are adjusted to thereby make it possible to change the beam quality, more specifically, the beam diameter or divergence angle of the laser beam L into which the plurality of laser beams LA and LB has been combined.

At this time, limitations may be imposed on the operation of the beam spacing changing units 32-1 and 32-2 so that the input numerical aperture NA_in does not exceed the maximum value of the input numerical aperture of the transmission fiber 40.

In addition, as illustrated in FIG. 2, the output numerical aperture NA_out at the output end of the transmission fiber 40 changes according to the input numerical aperture NA_in at the input end of the transmission fiber 40. That is, the output numerical aperture NA_out of the transmission fiber 40 can be changed as with the input numerical aperture NA_in. As described above, in the first embodiment, the numerical aperture changing apparatus 30 can greatly change the input numerical aperture NA_in between the above-described minimum value and maximum value. Thus, the variable range of the output numerical aperture NA_out can also be greatly changed according to the input numerical aperture NA_in.

Note that the above description has been made as to the numerical aperture changing apparatus 30 including the two beam spacing changing units 32-1 and 32-2, but this is merely an example. In a case where the beam characteristics of the laser beams LA and LB emitted from the laser oscillators 20A and 20B, respectively, differ between the X-axis direction and the Y-axis direction, the numerical aperture changing apparatus 30 just need to include two or more beam spacing changing units. However, when the beam characteristics of the laser beams LA and LB emitted from the laser oscillators 20A and 20B, respectively, are not directional in the X-axis direction and the Y-axis direction, the numerical aperture changing apparatus 30 may include a single beam spacing changing unit. In addition, although the rotation shafts 324-1 and 325-1 of the beam spacing changing unit 32-1 are perpendicular to the rotation shafts 324-2 and 325-2 of the beam spacing changing unit 32-2, this is also an example. The rotation shafts 324-1 and 325-1 of the beam spacing changing unit 32-1 and the rotation shafts 324-2 and 325-2 of the beam spacing changing unit 32-2 may extend in any directions provided that the rotation shafts 324-1 and 325-1 and the rotation shafts 324-2 and 325-2 are perpendicular to the optical axis of the transmission fiber 40 and the direction of the rotation shafts 324-1 and 325-1 is different from the direction of the rotation shafts 324-2 and 325-2.

Furthermore, the rotational positions of the beam rearrangement units 321-1 and 321-2, that is, the inclinations of the transmission plates 322-1, 322-2, 323-1, and 323-2 may be controlled in any desired manner. Alternatively, preset angles may be stored such that the transmission plates 322-1, 322-2, 323-1, and 323-2 may rotate through the preset angles according to commands from the control device 70.

The numerical aperture changing apparatus 30 of the first embodiment includes the plurality of beam spacing changing units 32-1 and 32-2. The beam spacing changing units 32-1 and 32-2 rearrange the plurality of laser beams LA and LB, and change the input numerical aperture NA_in of the transmission fiber 40 when the plurality of rearranged laser beams LA and LB is condensed to enter the transmission fiber 40. The plurality of beam spacing changing units 32-1 and 32-2 includes the light shielding members 326-1 and 326-2, respectively. The light shielding members 326-1 and 326-2 are provided on the sides closer to the transmission fiber 40 with respect to the beam spacing changing units 32-1 and 32-2, respectively, and provided in regions including the extension of the optical axis of the transmission fiber 40. As a result, a reflected laser beam, which is a laser beam reflected by the workpiece 61 and returning toward the laser oscillator 20 in the distribution centered on the optical axis of the transmission fiber 40, can be blocked without being transmitted toward the laser oscillator 20. That is, it is possible to control the output numerical aperture NA_out of the transmission fiber 40 as well as to prevent the laser oscillator 20 from failing due to the reflected laser beam. Furthermore, even when the volume of the laser beam reflected by the workpiece 61 is large, it is possible to cause the laser oscillator 20 to operate without failure.

In addition, the beam spacing changing unit 32-1 includes the two transmission plates 322-1 and 323-1 and the rotation mechanisms. The transmission plates 322-1 and 323-1 are rotatable about the rotation shafts 324-1 and 325-1, respectively. The rotation mechanisms drive and rotate the transmission plates 322-1 and 323-1 about the rotation shafts 324-1 and 325-1, respectively, in such a way as to achieve desired inclinations. In addition, the beam spacing changing unit 32-2 includes the two transmission plates 322-2 and 323-2 and the rotation mechanisms. The transmission plates 322-2 and 323-2 are rotatable about the rotation shafts 324-2 and 325-2, respectively. The rotation mechanisms drive and rotate the transmission plates 322-2 and 323-2 about the rotation shafts 324-2 and 325-2, respectively, in such a way as to achieve desired inclinations. In addition, the laser beam machine 1 includes the control device 70 that controls the inclinations of the transmission plates 322-1, 322-2, 323-1, and 323-2 via the rotation mechanisms. The control device 70 can change the beam spacings between the laser beams LA and LB by setting the inclinations of the two transmission plates 322-1 and 323-1 of the beam spacing changing unit 32-1 and the inclinations of the two transmission plates 322-2 and 323-2 of the beam spacing changing unit 32-2 to predetermined angles. That is, it is possible to control the input numerical aperture NA_in of the transmission fiber 40 between the minimum value and the maximum value. Furthermore, since the variable range of the input numerical aperture NA_in can be increased, the variable range of the output numerical aperture NA_out of the transmission fiber 40 can also be increased.

Moreover, the plurality of laser beams LA and LB is arranged in such a way as to be symmetric with respect to the extension of the optical axis of the transmission fiber 40. That is, the laser oscillators 20A and 20B are arranged in such a way as to be symmetric with respect to the extension of the optical axis of the transmission fiber 40. In addition, the transmission plates 322-1 and 323-1 of the beam spacing changing unit 32-1 are arranged in such a way as to be symmetric with respect to the extension of the optical axis of the transmission fiber 40. Furthermore, the transmission plates 322-2 and 323-2 of the beam spacing changing unit 32-2 are arranged in such a way as to be symmetric with respect to the extension of the optical axis of the transmission fiber 40. Thus, the beam quality of the laser beam L including the plurality of laser beams LA and LB can be made symmetrical. In addition, even in the case of the plurality of laser beams LA and LB having poor beam quality, the laser beams LA and LB can be rearranged such that the beam quality is improved.

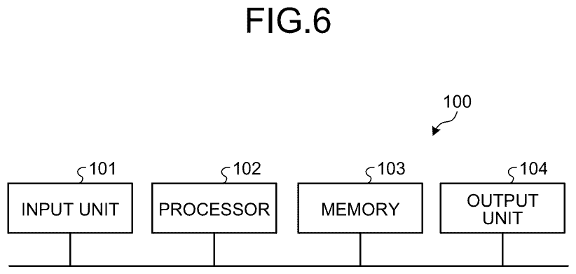

In one example, the control device 70 described above is implemented by processing circuitry serving as circuitry that causes a processor to execute software. The processing circuitry that causes the software to be executed is, for example, a control circuit illustrated in FIG. 6. FIG. 6 is a diagram illustrating an exemplary hardware configuration of the control device of the laser beam machine according to the first embodiment. A control circuit 100 includes an input unit 101, a processor 102, a memory 103, and an output unit 104.

The input unit 101 is an interface circuit that receives data input from the outside of the control circuit 100, and provides the data to the processor 102. The output unit 104 is an interface circuit that transmits data from the processor 102 or the memory 103 to the outside of the control circuit 100. In a case where the processing circuitry is the control circuit 100 illustrated in FIG. 6, the laser oscillator 20, the numerical aperture changing apparatus 30, the machining head 50, and the machining table 60 are implemented by the processor 102 reading and executing programs for controlling the laser oscillator 20, the numerical aperture changing apparatus 30, the machining head 50, and the machining table 60. The programs are stored in the memory 103. The memory 103 is also used as a temporary memory in each process to be performed by the processor 102. The processor 102 may output data such as a calculation result to the memory 103 to store the data in the memory 103, or may store the data such as a calculation result in an auxiliary storage device via a volatile memory of the memory 103.

The processor 102 is a central processing unit (CPU, also referred to as a processing device, an arithmetic device, a microprocessor, a microcomputer, a processor, or a digital signal processor (DSP)). Examples of the memory 103 include a nonvolatile or volatile semiconductor memories such as a random access memory (RAM), a read only memory (ROM), a flash memory, an erasable programmable read only memory (EPROM), and an electrically erasable programmable read only memory (EEPROM (registered trademark)), a magnetic disk, a flexible disk, an optical disk, a compact disk, a mini disk, and a digital versatile disc (DVD).

FIG. 6 illustrates an exemplary hardware to be used in a case where the control device 70 is implemented by the processor 102 and the memory 103 which are a general-purpose processor and a general-purpose memory, respectively. Meanwhile, the control device 70 may be implemented by a dedicated hardware circuit. Processing circuitry that is the dedicated hardware circuit is a single circuit, a composite circuit, a programmed processor, a parallel-programmed processor, an application specific integrated circuit (ASIC), a field-programmable gate array (FPGA), or a combination thereof. The above-described constituent elements may be implemented by a combination of the control circuit 100 and the dedicated hardware circuit.

The configurations set forth in the above embodiment show examples, and it is possible to combine the configurations with another known technique, and is also possible to partially omit or change the configurations without departing from the scope of the present disclosure.

### REFERENCE SIGNS LIST

1 laser beam machine; 10 laser apparatus; 20, 20A, 20B laser oscillator; 30 numerical aperture changing apparatus; 31 beam spacing changer; 32-1, 32-2 beam spacing changing unit; 33 condensing optical system; 40 transmission fiber; 41 core; 42 cladding; 50 machining head; 51 transmission optical system; 60 machining table; 61 workpiece; 70 control device; 100 control circuit; 101 input unit; 102 processor; 103 memory; 104 output unit; 321-1, 321-2 beam rearrangement unit; 322-1, 322-2, 323-1, 323-2 transmission plate; 324-1, 324-2, 325-1, 325-2 rotation shaft; 326-1, 326-2 light shielding member; A1, A2 straight line; L, LA, LB laser beam.

1. A numerical aperture changing apparatus for rearranging spatial distributions or spatial positions of a plurality of laser beams incident from a laser oscillator, and condensing the plurality of rearranged laser beams for entry of the beams into a transmission fiber, the numerical aperture changing apparatus comprising:
a light shielding member provided on an extension of an optical axis of the transmission fiber, the light shielding member blocking a reflected laser beam, the reflected laser beam being a laser beam traveling from the transmission fiber toward the laser oscillator.

2. The numerical aperture changing apparatus according to claim 1, wherein the light shielding member has a size such that output loss of the plurality of laser beams is 10% or less when the spatial distributions or the spatial positions of the plurality of incident laser beams are brought closest to each other in the numerical aperture changing apparatus.

3. The numerical aperture changing apparatus according to claim 1, wherein the light shielding member is disposed such that output loss of the plurality of laser beams is 10% or less when the spatial distributions or the spatial positions of the plurality of incident laser beams are brought closest to each other in the numerical aperture changing apparatus.

4. The numerical aperture changing apparatus according to claim 1, wherein the light shielding member is formed of a material that absorbs or reflects the reflected laser beam.

5. The numerical aperture changing apparatus according to claim 4, wherein the light shielding member includes a cooling mechanism.

6. The numerical aperture changing apparatus according to claim 1, comprising:
a plurality of beam spacing changers to change beam spacings between the plurality of incident laser beams, wherein
the light shielding member is provided for each of the plurality of beam spacing changers, and is located on a side closer to the transmission fiber with respect to each of the plurality of beam spacing changers.

7. The numerical aperture changing apparatus according to claim 6, further comprising:
a controller to control operation of the plurality of beam spacing changers, wherein
each of the plurality of beam spacing changers includes:
a beam rearrangement unit including a plurality of transmission plates disposed at a predetermined interval, the plurality of transmission plates transmitting the laser beams; and
a rotator to rotate each of the plurality of transmission plates about a rotation shaft, and
the controller controls the rotator such that the plurality of laser beams enters the plurality of transmission plates at predetermined angles.

8. The numerical aperture changing apparatus according to claim 7, wherein
the plurality of laser beams enters the numerical aperture changing apparatus symmetrically with respect to the extension of the optical axis of the transmission fiber, and
the plurality of transmission plates is disposed symmetrically with respect to the extension of the optical axis of the transmission fiber.

9. A laser apparatus comprising:
the numerical aperture changing apparatus according to claim 1; and
the laser oscillator to cause the plurality of laser beams to enter the numerical aperture changing apparatus.

10. A laser beam machine comprising:
the laser apparatus according to claim 9;
a transmission fiber to propagate the plurality of laser beams from the laser apparatus; and
a machining head to irradiate a workpiece with the plurality of laser beams from the transmission fiber.
